(19) United States
(12) Patent Application Publication
(10) Pub. No.: US 2008/0006009 A1
(43) Pub. Date: Jan. 10, 2008

(54) Air cleaner nightlight

(75) Inventors: Bruce Kiern, Gulfport, MS (US); Christopher M. Paterson, Biloxi, MS (US); John Relman Bohlen, Gulfport, MS (US)

Correspondence Address: THE OLLILA LAW GROUP LLC, 2060 BROADWAY, SUITE 300, BOULDER, CO, 80302, US

(73) Assignee: Oreck Holdings, LLC

(21) Appl. No.: 11/481,321

(22) Filed: Jul. 5, 2006

(51) Int. Cl. B01D 46/00

(52) U.S. Cl. 55/385.1; 55/471

(57) ABSTRACT

An air cleaner nightlight is provided according to the invention. The air cleaner nightlight includes an air cleaner including an external shell and a nightlight formed in the external shell. The nightlight includes one or more light emitting diodes (LEDs).

### TECHNICAL FIELD

The present invention relates to an air cleaner, and more particularly, to an air cleaner nightlight.

### BACKGROUND OF THE INVENTION

Air cleaners are widely used in home and office settings for cleaning the air. An air cleaner can filter the air in order to remove airborne contaminants. An air cleaner can therefore include any type of mechanical filter element comprising a mesh, a weave, a foam, etc. An air cleaner can further include electrical air cleaning components, including ionizers, electrostatic precipitators, etc.

An air cleaner is typically placed and kept in a dwelling. Because an air cleaner may be kept in a room or rooms for a long period of time, it essentially becomes a utilitarian item of furniture. Therefore, it is desirable that an air cleaner perform more than one function.

### SUMMARY OF THE INVENTION

An air cleaner nightlight is provided according to an embodiment of the invention. The air cleaner nightlight comprises an air cleaner including an external shell and a nightlight formed in the external shell. The nightlight comprises one or more light emitting diodes (LEDs).

An air cleaner nightlight is provided according to an embodiment of the invention. The air cleaner nightlight comprises an air cleaner including an external shell, a nightlight formed in the external shell, and a nightlight control formed in the external shell. The air cleaner is configured to receive a nightlight control activation, ramp up electrical current to the nightlight if power to the nightlight is turned on by the nightlight control activation, and ramp down electrical current to the night light if power to the nightlight is turned off by the nightlight control activation.

A nightlight method in an air cleaner is provided according to an embodiment of the invention. The method comprises receiving a nightlight control activation in the air cleaner and illuminating a nightlight of the air cleaner if power to the nightlight is turned on by the nightlight control activation. The nightlight comprises one or more light emitting diodes (LEDs).

A nightlight method in an air cleaner is provided according to an embodiment of the invention. The method comprises receiving a nightlight control activation in the air cleaner, ramping up electrical current to a nightlight of the air cleaner if power to the nightlight is turned on by the nightlight control activation, and ramping down electrical current to the night light if power to the nightlight is turned off by the nightlight control activation.

### BRIEF DESCRIPTION OF THE DRAWINGS

The same reference number represents the same element on all drawings. It should be noted that the drawings are not necessarily to scale.

FIG. 1 shows an air cleaner according to an embodiment of the invention.

FIG. 2 shows detail of the control panel according to an embodiment of the invention.

FIG. 3 is a cross-sectional view of the nightlight according to an embodiment of the invention.

### DETAILED DESCRIPTION OF THE INVENTION

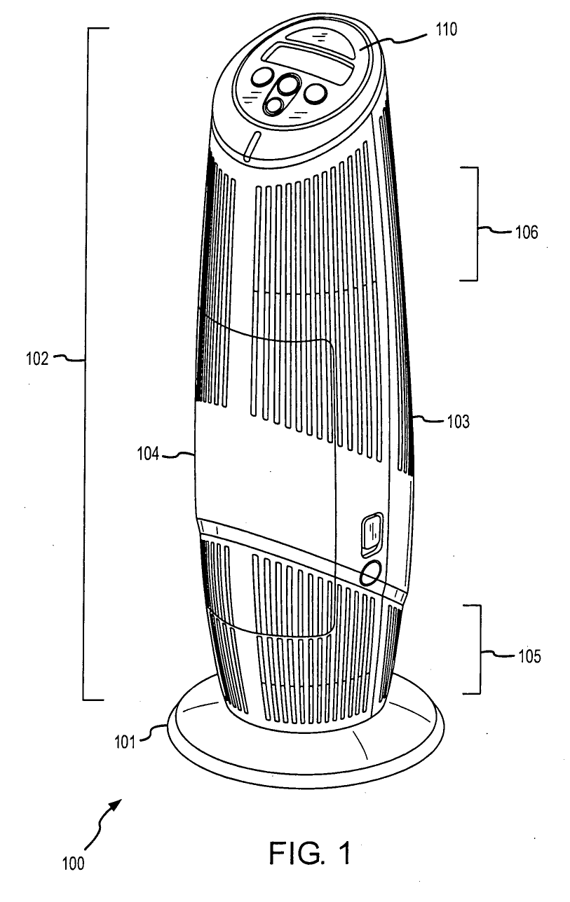

FIGS. 1-3 and the following descriptions depict specific embodiments to teach those skilled in the art how to make and use the best mode of the invention. For the purpose of teaching inventive principles, some conventional aspects have been simplified or omitted. Those skilled in the art will appreciate variations from these embodiments that fall within the scope of the invention. Those skilled in the art will also appreciate that the features described below can be combined in various ways to form multiple variations of the invention. As a result, the invention is not limited to the specific embodiments described below, but only by the claims and their equivalents.

FIG. 1 shows an air cleaner 100 according to an embodiment of the invention. The air cleaner 100 in the embodiment shown includes a base portion 101 and a tower portion 102. The tower portion 102 can be generally vertically positioned and elongate in shape. In one embodiment, the tower portion 102 can be substantially cylindrical in shape. However, it should be understood that the air cleaner 100 can comprise any configuration, such as substantially rectangular, substantially round, a tower, etc. The air cleaner 100 can comprise a floor air cleaner model, a table top air cleaner model, a portable or personal air cleaner model, etc.

The tower portion 102 includes an external shell 103, one or more doors 104, and a control panel 110. The tower portion 102 further includes an air inlet 105 and an air outlet 106. Air is drawn in through the air inlet 105, is cleaned inside the tower portion 102, and the cleaned air is exhausted from the air outlet 106. However, it should be understood that the air cleaner 100 can comprise other shapes, configurations, and designs, and the tower configuration is shown merely for illustration.

The air inlet 105 is shown as being at the lower end of the tower portion 102. However, it should be understood that alternatively the relative positions of the air inlet 105 and the air outlet 106 could be interchanged.

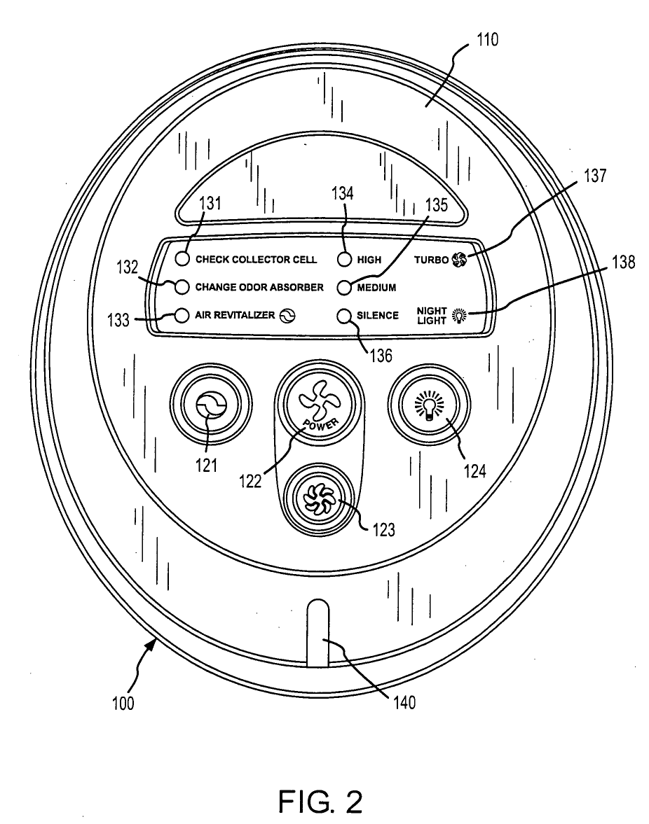

FIG. 2 shows detail of the control panel 110 according to an embodiment of the invention. The control panel 110 includes various controls, including an air revitalizer (i.e., ionizer) button 121, a fan power button 122, a fan turbo button 123, and a nightlight control 124.

Pressing the air revitalizer button 121 turns the air revitalizer on and off. Pressing the fan power button 122 cycles the fan of the air cleaner 100 through the fan power levels. To turn the air cleaner 100 on, the user presses the fan power button 122 once. Power comes on in the low i.e., “silence” setting. Subsequent presses of the fan power button 122 transitions the fan to the medium speed, to the high speed, and then turns the fan off. The electrostatic precipitator cell is turned on when the fan is running at any speed. Pressing the fan turbo button 123 runs the fan at its highest speed, the turbo speed. This speed setting is accompanied by illumination of the turbo fan speed indicator 137. The electrostatic precipitator is on when the fan is at the turbo speed setting. The turbo speed setting can be turned off by a subsequent press of the fan turbo button 123 or by cycling off the power of the air cleaner 100, for example.

The control panel further includes various visual indicators, including a check collector cell indicator 131, a change odor absorber indicator 132, an air revitalizer indicator 133, a high fan speed indicator 134, a medium fan speed indicator 135, a silence fan speed indicator 136, a turbo fan speed indicator 137, and a nightlight indicator 138.

The check collector cell indicator 131 is generally illuminated when a collector cell (i.e., electrostatic precipitator) of the air cleaner 100 is dirty and requires cleaning. The collector cell may require cleaning after a predetermined number of hours of operation, for example. The check collector cell indicator 131 can be illuminated when a corresponding collector cell timer indicates that a predetermined time period has elapsed.

The change odor absorber indicator 132 is generally illuminated when an odor absorber requires replacement. The odor absorber may require replacement when an odor absorber material has been consumed or effectively clogged up. The change odor absorber indicator 132 can be illuminated when a corresponding odor absorber timer indicates that a predetermined time period has elapsed.

The air revitalizer indicator 133 is generally illuminated when the air revitalizer (i.e., air ionizer) is operating and ionizing airflow through the air cleaner 100. The air revitalizer indicator 133 is correspondingly turned on and off when the air revitalizer is turned on and off.

The high fan speed indicator 134 is generally illuminated during a high fan output setting. The high indicator 134 is correspondingly turned on and off when the high fan output setting is turned on and off.

The medium fan speed indicator 135 is generally illuminated during a medium fan output setting. The medium indicator 135 is correspondingly turned on and off when the medium fan output setting is turned on and off.

The silence fan speed indicator 136 is generally illuminated during a lowest fan output setting. The silence mode of the air cleaner 100 is therefore relatively quiet. The silence fan speed indicator 136 is correspondingly turned on and off when the silence fan output setting is turned on and off.

The turbo fan speed indicator 137 is generally illuminated during turbo mode operation of a fan motor (or motors). The turbo mode is a highest fan output setting. In some embodiments, the turbo mode is automatically controlled by the air cleaner 100, and cannot be activated by a person. The turbo fan speed indicator 137 is correspondingly turned on and off when the turbo fan output setting is turned on and off.

The nightlight indicator 138 is generally illuminated when a nightlight 140 (see below) is activated. The nightlight indicator 138 is correspondingly turned on and off when the nightlight 140 is turned on and off.

The air cleaner 100 further includes a nightlight 140. The nightlight 140 can comprise a light source. The nightlight 140 can comprise one or more light emitting diodes (LEDs).

The nightlight 140 in the embodiment shown is positioned at or near the top of the tower portion 102 of the air cleaner 100. Consequently, the nightlight 140 is substantially adjacent to the control panel 110. The nightlight 140 in some embodiments is substantially elongate in shape, as shown. However, it should be understood that the nightlight 140 can comprise any shape and size.

The nightlight 140 can perform as a typical nightlight. The nightlight 140 generates light and at least partially illuminates a surrounding area. The nightlight 140 can further illuminate the control panel 110 and enable a person to find the buttons or controls at night.

When the nightlight control 124 is activated, the nightlight 140 is turned on. If the nightlight control 124 comprises a button, the activation can comprise a button press, for example. In addition, the nightlight indicator 138 is illuminated. A subsequent de-activation of the nightlight control 124 turns off the nightlight 140 and the nightlight indicator 138.

It should be understood that the nightlight control 124 can comprise any manner of control mechanism. The nightlight control 124 can comprise a switch, button, slider, optical sensor, touch sensor, etc. Other nightlight controls are contemplated and are within the scope of the description and claims.

In some embodiments, electrical current to the nightlight 140 is ramped up or down when the nightlight control 124 is activated or de-activated, and is not merely turned on or off. The electrical current to the nightlight 140 is ramped up if power to the nightlight 140 is turned on by a nightlight control activation and the electrical current is ramped down if power to the nightlight 140 is turned off by a nightlight control de-activation. In addition, the ramping can comprise stepping the electrical current up or down, wherein the electrical current is stepped up or down over a predetermined ramp up or ramp down time period. The stepping can include a predetermined number of current levels.

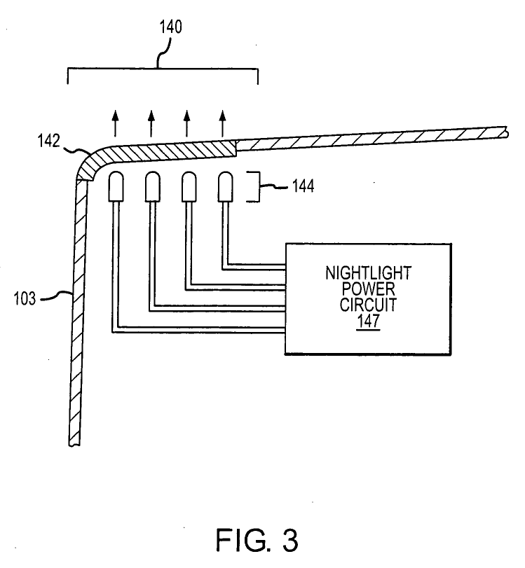

FIG. 3 is a cross-sectional view of the nightlight 140 according to an embodiment of the invention. The nightlight 140 comprises a lens 142 retained in the external shell 103 and a plurality of light sources 144. The plurality of light sources 144 are positioned to direct emitted light into the lens 142 and therefore to the exterior of the air cleaner 100.

The plurality of light sources 144 in one embodiment comprises a plurality of light emitting diodes (LEDs) 144. In one embodiment, the light sources 144 comprise color light sources 144, such as blue LEDs, for example. However, it should be understood that other light sources are contemplated and are within the scope of the description and claims.

In an alternative to the previous nightlight ramping embodiment, the nightlight 140 can be ramped up or down by selectively illuminating individual light sources 144. For example, just one light source 144 can first be supplied with electrical current. Then an additional light source 144 is supplied with electrical current, and another, etc.

What is claimed is:

1. An air cleaner nightlight, comprising:
an air cleaner including an external shell; and
a nightlight formed in the external shell, with the nightlight comprising one or more light emitting diodes (LEDs).

2. The air cleaner nightlight of claim 1, with the nightlight comprising a lens affixed to the external shell, with the one or more LEDs being positioned to direct emitted light into the lens.

3. The air cleaner nightlight of claim 1, with the nightlight comprising a lens affixed to the external shell, with the one or more LEDs comprising a predetermined color and being positioned to direct emitted light into the lens.

4. The air cleaner nightlight of claim 1, with the air cleaner nightlight further comprising a nightlight control, with the air cleaner being configured to receive a nightlight control activation, ramp up electrical current to the nightlight if power to the nightlight is turned on by the nightlight control activation, and ramp down electrical current to the night light if power to the nightlight is turned off by the nightlight control activation.

5. The air cleaner nightlight of claim 4, with the ramping up occurring over a predetermined ramp up time period.

6. The air cleaner nightlight of claim 4, with the ramping down occurring over a predetermined ramp down time period.

7. The air cleaner nightlight of claim 4, with the ramping up comprising stepping up the electrical current over a predetermined ramp up time period.

8. The air cleaner nightlight of claim 4, with the ramping down comprising stepping down the electrical current over a predetermined ramp down time period.

9. An air cleaner nightlight, comprising:
an air cleaner including an external shell;
a nightlight formed in the external shell; and
a nightlight control formed in the external shell, with the air cleaner being configured to receive a nightlight control activation, ramp up electrical current to the nightlight if power to the nightlight is turned on by the nightlight control activation, and ramp down electrical current to the night light if power to the nightlight is turned off by the nightlight control activation.

10. The air cleaner nightlight of claim 9, with the nightlight comprising:
a lens affixed to the external shell; and
one or more light sources positioned to direct emitted light into the lens.

11. The air cleaner nightlight of claim 9, with the nightlight comprising:
a lens affixed to the external shell; and
one or more light emitting diodes (LEDs) positioned to direct emitted light into the lens.

12. The air cleaner nightlight of claim 9, with the nightlight comprising:
a lens affixed to the external shell; and
one or more light emitting diodes (LEDs) of a predetermined color positioned to direct emitted light into the lens.

13. The air cleaner nightlight of claim 9, with the ramping up occurring over a predetermined ramp up time period.

14. The air cleaner nightlight of claim 9, with the ramping down occurring over a predetermined ramp down time period.

15. The air cleaner nightlight of claim 9, with the ramping up comprising stepping up the electrical current over a predetermined ramp up time period.

16. The air cleaner nightlight of claim 9, with the ramping down comprising stepping down the electrical current over a predetermined ramp down time period.

17. A nightlight method in an air cleaner, the method comprising:
receiving a nightlight control activation in the air cleaner; and
illuminating a nightlight of the air cleaner if power to the nightlight is turned on by the nightlight control activation, with the nightlight comprising one or more light emitting diodes (LEDs).

18. The nightlight method of claim 17, with the nightlight comprising a lens affixed to the external shell, with the one or more LEDs being positioned to direct emitted light into the lens.

19. The nightlight method of claim 17, with the nightlight comprising a lens affixed to the external shell, with the one or more LEDs comprising a predetermined color and being positioned to direct emitted light into the lens.

20. The nightlight method of claim 17, with the air cleaner nightlight further comprising a nightlight control, with the air cleaner being configured to receive a nightlight control activation, ramp up electrical current to the nightlight if power to the nightlight is turned on by the nightlight control activation, and ramp down electrical current to the night light if power to the nightlight is turned off by the nightlight control activation.

21. The nightlight method of claim 20, with the ramping up occurring over a predetermined ramp up time period.

22. The nightlight method of claim 20, with the ramping down occurring over a predetermined ramp down time period.

23. The nightlight method of claim 20, with the ramping up comprising stepping up the electrical current over a predetermined ramp up time period.

24. The nightlight method of claim 20, with the ramping down comprising stepping down the electrical current over a predetermined ramp down time period.

25. A nightlight method in an air cleaner, the method comprising:
receiving a nightlight control activation in the air cleaner;
ramping up electrical current to a nightlight of the air cleaner if power to the nightlight is turned on by the nightlight control activation; and
ramping down electrical current to the night light if power to the nightlight is turned off by the nightlight control activation.

26. The nightlight method of claim 25, with the nightlight comprising:
a lens affixed to the external shell; and
one or more light sources positioned to direct emitted light into the lens.

27. The nightlight method of claim 25, with the nightlight comprising:
a lens affixed to the external shell; and
one or more light emitting diodes (LEDs) positioned to direct emitted light into the lens.

28. The nightlight method of claim 25, with the nightlight comprising:
a lens affixed to the external shell; and
one or more light emitting diodes (LEDs) of a predetermined color positioned to direct emitted light into the lens.

29. The nightlight method of claim 25, with the ramping up occurring over a predetermined ramp up time period.

30. The nightlight method of claim 25, with the ramping down occurring over a predetermined ramp down time period.

31. The nightlight method of claim 25, with the ramping up comprising stepping up the electrical current over a predetermined ramp up time period.

32. The nightlight method of claim 25, with the ramping down comprising stepping down the electrical current over a predetermined ramp down time period.
